(19) United States
(12) Patent Application Publication
(10) Pub. No.: US 2012/0303524 A1
(43) Pub. Date: Nov. 29, 2012

(54) SYSTEM AND METHOD FOR RECEIVER STAGED MONEY TRANSFER TRANSACTIONS

(75) Inventors: Tara Bertram, Maple Grove, MN (US); Kunle Olamuyiwa, Agege (NG); Sabrina Chan, Happy Valley (HK); Douglas Dalton, St. Michael, MN (US); Richard Meszaros, Bloomington, MN (US)

(73) Assignee: MONEYGRAM INTERNATIONAL, INC., St. Louis Park, MN (US)

(21) Appl. No.: 13/113,765

(22) Filed: May 23, 2011

(51) Int. Cl. G06Q 40/00

(52) U.S. Cl. 705/44

(57) ABSTRACT

A computer system is operated for a receiver-staged money transfer transaction. A staged transaction is received from a receiver and includes one or more items requested by the receiver. Information about one or more senders identified to receive the staged transaction is then received, and the staged transaction is sent to the one or more senders. Approval notifications are received from the one or more senders indicating the one or more items in the staged transaction that the one or more senders agree to fulfill. The requested items fulfilled by the one or more senders are then released to the receiver

### TECHNICAL FIELD

The present invention relates to computer systems for money transfers. More particularly, the present invention is a computer system that facilitates staging of money transfer transactions by the receiver of the money transfer.

### BACKGROUND

A number of businesses offer money transfer and other services through a network of agents. A customer that desires to use these services to transfer money to a third party can take the money to an agent of the money transfer service. The agent accepts the money, obtains necessary information such as the customer's identity and the identity of the receiver, and initiates a transaction. The money is then made available to the receiver by another agent.

When a money transfer transaction is sent, the sender is not able to control or determine how the money is used by the money transfer receiver. For example, the receiver may indicate to the sender a desire to purchase a particular good or commodity, and solicit the sender to provide a money transfer to cover the cost of the desired good or commodity. However, when the sender transmits the money transfer, the sender is limited in his or her ability to verify that the transferred money is actually used to purchase the good or commodity identified by the receiver.

The receiver is also limited in determining the format and application of the money transfer fund. For example, upon redemption, the receiver is typically given cash in the amount of the money transfer. However, in some situations, non-cash type payments are preferred or required, such as payment of bills and other expenses. To this end, any delay between the transmission and redemption of the money transfer transaction, or the redemption and subsequent conversion of cash to a format suitable for paying the bills, can lead to missed payment deadlines.

### SUMMARY

In one aspect, the present invention relates to a method for operating a computer system for a receiver-staged money transfer transaction. A staged transaction is received from a receiver and includes one or more items requested by the receiver. Information about one or more senders identified to receive the staged transaction is then received, and the staged transaction is sent to the one or more senders. Approval notifications are received from the one or more senders indicating the one or more items in the staged transaction that the one or more senders agree to fulfill. The requested items fulfilled by the one or more senders are then released to the receiver.

In another aspect, the present invention relates to a system for facilitating staging of money transfer transactions by a receiver. The system includes a server that communicates with a plurality of computers. The server is configured to receive a staged transaction from the receiver that includes one or more items requested by the receiver. The server is also configured to receive information about one or more senders identified to receive the staged transaction request, and to send the staged transaction to the one or more senders. In addition, the server is configured to receive approval notifications from the one or more senders indicating the one or more items in the staged transaction that the one or more senders agree to fulfill. The server is further configured to release the requested items fulfilled by the one or more senders to the receiver.

In a further aspect, the present invention relates to a method for operating a computer system to facilitate a receiver staged money transfer transaction. A receiver interface is provided on a receive computer that allows the receiver to generate a staged transaction that includes one or more items requested by the receiver. The receiver is prompted on the receiver interface to identify and select one or more senders to receive the staged transaction request. A sender interface is provided on one or more send computers that allows the one or more senders to review the one or more items requested in the staged transaction request, and the one or more senders are prompted to approve or deny fulfillment of the one or more items. Status information is provided on the receiver interface as to whether each of the one or more items in the staged transaction has been fulfilled. The receiver interface also provides an option for the receiver to request release of the fulfilled one or more items.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system for receiver staging of money transfer transactions for fulfillment by one or more senders.

FIG. 2 is a flow diagram of an embodiment of a process for coordinating receiver staging of a money transfer transaction and fulfillment of the transaction by one or more senders.

### DETAILED DESCRIPTION

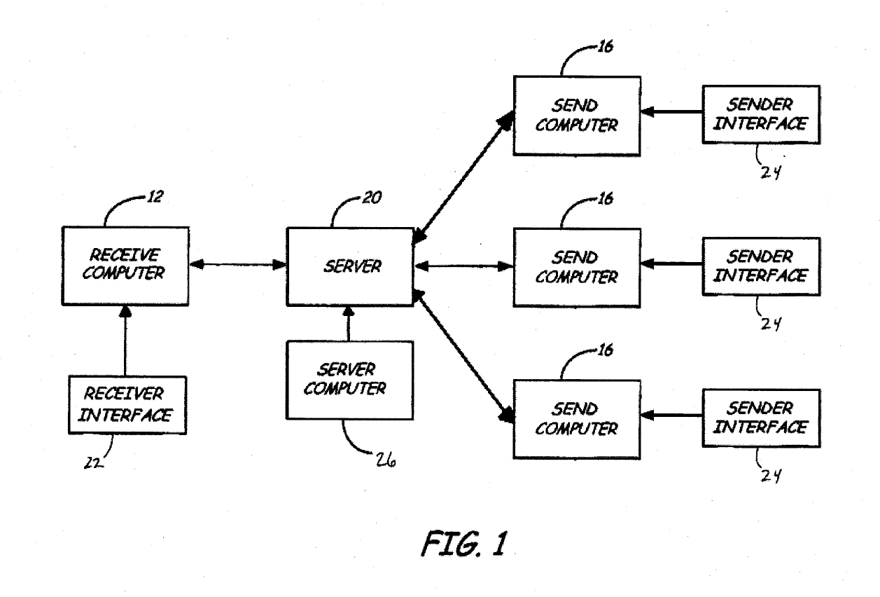

FIG. 1 is a block diagram of an embodiment of a system 10 for receiver staging of money transfer transactions. The staged money transfer transactions are fulfilled by one or more senders. System 10 includes a receive computer 12 at a receive location and one or more send computers 16 at a send location. In actual implementation the system 10 may include any number of networked receive computers 12 and send computers 16. In the embodiment illustrated in FIG. 1, one receive computer 12 and three send computers 16 are shown.

The receive computer 12 and the one or more send computer 16 communicate with a central server 20, for example via a communication network such as the internet. In some embodiments, a receiver interface 22 is connected to the receive computer 12, and a sender interface 24 is connected to each of the send computers 16. The system 10 facilitates the staging of money transfers through the receive computer 12, and the review and fulfillment of the money transfer via any of the send computers 16. As will be described in more detail herein, the receive computer 12 is associated with a receiver seeking money, commodities, or other items of value, and the send computers 16 are associated with individuals identified by the receiver to fulfill the items requested by the receiver. The server 20 coordinates the requesting and approval processes for sending and receiving money transfers.

The receive computer 12 may be located at a facility that is approved by a financial services organization to stage money transfer or purchase requests for a receiver. For example, the receive computer 12 may be located at a store or dedicated location that provides redemption services for money transfers. In some embodiments, the receive computer 12 is located at a facility that allows the receiver to redeem fulfilled transaction requests. Alternatively, the receive location may access the server 20 remotely, such as via a telephone call or the internet. The receive computer 12 may be operated by an agent at the approved receive location. The receive computer 12 may include software that facilitates entry of information by a receiver via the receiver interface 22 to stage a money transfer for subsequent transmission to the server 20 for approval. For example, the staged transaction may include information about the receiver, the items requested by the receiver (e.g., money, commodities, etc.), and information about one or more senders to receive the staged request. The receive location may also include a telephone or other voice communications device (not shown) to contact the financial services organization if questions arise during the money transfer staging process.

In alternative embodiments, the receive computer 12 may be any computer configured to provide information to the server 20 via a secure internet or server connection. For example, the receive computer 12 may be a home computer, kiosk, or other interactive device. The receive computer 12 may include a browser or other application that provides a user interface for a receiver to enter information to stage a transaction. The browser may allow for entry of receiver and sender identification information. As another example, the receive computer 12 may be configured to receive money transfer staging information from the receiver via telephone or interactive voice recognition systems. As a further example, a telephone may be used to contact a call center (not shown) to stage a transaction.

The send computers 16 may be located at institutions that are approved by the financial services organization to facilitate sender review of money transfer transaction requests staged by the receiver and to allow approval or denial of the transaction requests by the senders. The send computers 16 at the send locations may be operated by an approved agent for the financial institution using the sender interfaces 24. The send computers 16 may include software to facilitate retrieval of information about staged money transfers sent by the receiver. The operator of each send computer 16 may also, in some cases, review the information associated with the money transfer, such as the amount and purpose of the money transfer funds. The send computer 16 may also allow entry of sender account or payment information which may authorize withdrawal of funds from an account with a financial institution to fund the money transfer. The send location may also include a telephone or other voice communications device to contact the financial services organization if questions arise during review or and response to the staged money transfer requests.

In alternative embodiments, one or more of the send computers 16 may be any computer configured to provide information to the server 20 via a secure internet or server connection. For example, any of the send computers 16 may be a home computer, kiosk, or other interactive device. The send computers 16 may include a web browser or other application that provides a user interface for a sender to review a staged transaction and to enter information to respond to the staged transaction. The web browser may allow for entry of sender identification and account information. As another example, the send computers 16 may be configured to receive information from the senders via telephone or interactive voice recognition systems. As a further example, a telephone may be used to contact a call center (not shown) to review and respond to a staged transaction.

The server 20 may be housed and/or operated by or on behalf of the financial services organization that, among other functions, approves and coordinates staging of receive transactions from the receive computer 12, communicates with the send computers 16 to receive fulfillment approvals or denials from the senders, communicate status information regarding the staged receive transaction to the receive computer 12, and facilitate redemption by the receiver of the fulfilled items in the staged transaction. The server 20 also facilitates approval of staged receive transactions from the receive computer 12. In some embodiments, the server 20 is configured to automatically process staged receive transactions from the receive computer 12 and fulfillment responses from send computers 16. In other embodiments, the server 20 provides information to a user at the financial services organization for review and approval. For example, the server 20 may be connected to a computer 26 that provides an interface to a user at the financial services organization to review and approve or deny communications associated with the staged receive transactions. In some embodiments, the server 20 provides compliance functions for the staged money transfer transaction. The server 20 includes storage capabilities to store information from staged receive transactions for later retrieval during the money transfer fulfillment process. In addition, the server 20 may store other information such as, for example, past customer money transfer send/receive activity, customer account information, and computer identification and log-in information for the receive computer 12 and send computers 16.

As will be described in more detail herein, the system 10 allows an individual (i.e., a receiver) to stage a money transfer transaction for one or more items that the individual wishes to receive. This staged transaction is then provided to one or more parties (i.e., senders) that can then review the one or more items desired by the receiver and decide whether to provide the funds required to fulfill any of the requested items for the receiver. The receiver can check on the fulfillment status of the requested items after staging the transaction. Depending on the form of the items fulfilled, the receiver may request release of any fulfilled items by the financial services organization, or the receiver may be provided with the fulfilled items upon fulfillment by the sender(s).

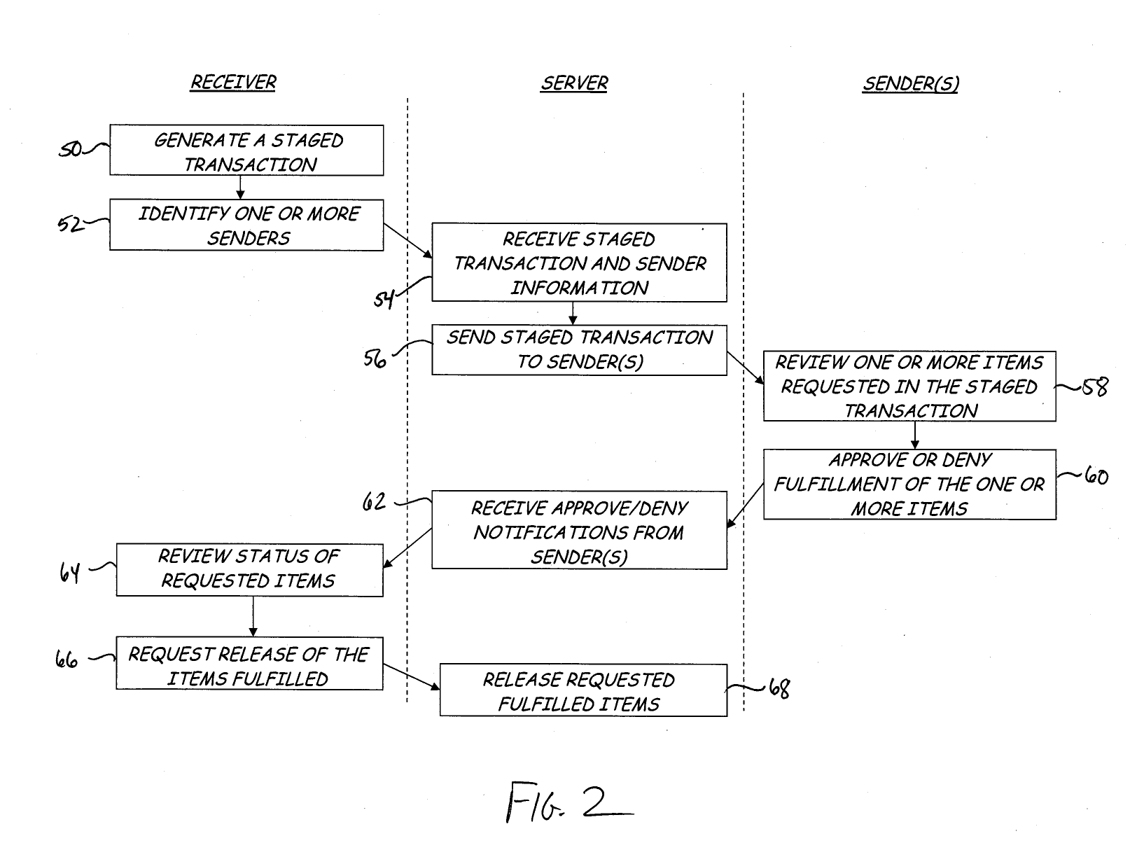

FIG. 2 is a flow diagram of an embodiment of a process for coordinating receiver staging of a money transfer transaction and fulfillment of the transaction by one or more senders. In step 50, the receiver generates a staged transaction on the receive computer 12 via the receiver interface 22. This may occur at a receive location as described above, on a home computer or cell phone connected to the internet via a secure connection, via text (SMS) messaging, through a call center or interactive voice recognition (IVR) system, through social media sites, or through any other medium or means by which a receive transaction can be staged.

The receiver may be prompted via an interface on the receive computer 12 for various information for the staged transaction. For example, the receiver may be prompted to provide identifying information, such as the receiver's name, address, social security number, telephone number, email address, and the like. If the receiver has previously sent or received money transfers through the system 10, the receiver may be able to provide a name or secure login information on the receive computer 12, and the remaining information may be retrieved from the server 20.

The receiver may also be prompted to provide information regarding one or more items that the receiver would like to receive when the staged transaction is fulfilled. The items may include anything of value that the receiver wishes to have paid for or provided by one or more senders. For example, the items included in the staged transaction includes cash for spending as the receiver wishes. The receiver may specify a monetary amount that the receiver wishes to receive which, upon fulfillment by one or more senders, may be redeemed at a receive location affiliated with the financial services organization that oversees the system 10. The money may also be transferred to an account at a financial institution associated with the receiver. The receiver may alternatively specify a third party to whom the cash is to be provided.

As another example, the one or more items requested by the receiver may include bill or expense payment requests. More specifically, the receiver may wish to have a bill paid by one or more senders directly to the biller on behalf of receiver, or on behalf of a third party identified by the receiver in the staged transaction. To facilitate this, the receiver may provide the biller's information (e.g., name and address) and an account number to which the requested funds should be applied. Allowing a receiver to apply funds directly to a biller provides several advantages over providing cash to the receiver to pay the bills. For example, paying the bills directly reduces the amount of time needed to get the funds to the biller, thereby reducing the likelihood of late payment fees. In addition, being able to pay the biller directly eliminates worry on the part of the sender that the receiver (or identified third party) will use the money for a different purpose.

The one or more items requested by the receiver may also include commodities selected by the receiver. For example, the receiver may select goods or services from a store or website that the receiver wishes to receive. In some embodiments, the receiver may access a website for a merchant and select one or more goods to receive. Upon checking out at the merchant website, the receiver may provide information regarding receipt of the goods from the merchant (e.g., shipping address). When all information is entered, the receiver may be provided with a biller code that can be provided with the staged transaction request. When the goods are fulfilled in the staged transaction request, the system 10 uses the biller code to settle the transaction with the merchant using funds provided by the sender. In some embodiments, the system 10 provides the receiver with the ability to associate the staged transaction with lists or selections on a merchant's website, such as a wish lists, wedding registry, or baby registry. The ability to request commodities in a staged transaction fulfills an actual need of the receiver, allows the commodities to be delivered directly to the receiver's home after fulfillment, and eliminates worry on the part of the sender that the receiver (or identified third party) will use the money for a different purpose.

After the receiver has staged the money transfer transaction, in step 52, the receiver identifies one or more senders to whom the staged transaction is to be sent. The receive computer 12 may prompt the receiver to enter information about the one or more senders, such as the sender's name, sender's address, sender's telephone number, and other identifying information. If the receiver has previously specified senders in earlier transactions, the receiver may be provided with a list of these senders to select for the transaction being staged.

The receiver may also associate certain of the one or more requested items in the staged transaction with specific senders. That is, the receiver may specify that only certain senders are to receive requests for specific items, or specific categories of items (e.g., cash, bill and expense payment, commodities). For example, the receiver may identify three senders that are to receive items categorized as bill and expense payment transactions. In some embodiments, the receiver may request that all bill and expense payment transactions are sent to the three identified senders simultaneously. In other embodiments, the receiver may request that all bill and expense payment transactions are sent to the three identified senders in a certain order (i.e., sequentially) until each of the bill and expense payment transactions are fulfilled.

When all information has been provided to stage the transaction, the receive computer 12 sends the staged transaction and sender information to the server 20 for processing. In step 54, the server 20 receives the staged transaction and sender information from the receive computer 12. The server 20 may store the information in the staged transaction, assure the parties to the money transfer transaction are in compliance with regulatory and fraud requirements, and/or provide any necessary information to identified third parties, such as billers or merchants, related to the staged transaction.

After processing the staged transaction, in step 56, the server 20 may send the staged transaction to the one or more senders identified in the staged transaction request. In some embodiments, all senders are provided with all requested items in the staged transaction. In other embodiments, each sender is provided with only the requested items that the receiver associated with the sender. Multiple senders may be provided with the same item(s) so that the likelihood of a requested item being fulfilled is increased. In addition, multiple senders may share the burden of a single item. The senders may be notified of the staged transaction via a webpage, email, text message (SMS), social media, or any other service or medium capable of alerting the senders of the staged transaction. In some embodiments, the receiver specifies the preferred method of notification for some or all of the senders. The receiver may also specify the preferred method of receiving information about responses to the staged transaction.

In step 58, the one or more senders may then review the items requested in the staged transaction. The senders may each be provided with an interface on the send computer 16 listing the items requested by the receiver, as well as a monetary value associated with each item. In some embodiments, the items listed may be include a note from the receiver indicating the need for the items. In the case of commodities, the listed items may also include links to merchant websites to allow the sender to view more information about each commodity on the staged transaction.

In step 60, each sender may decide whether to approve or deny any or all of the requested items in the staged transaction. In some embodiments, the sender can respond to the staged transaction via the same channel as notification of the staged transaction was received (e.g., email, text, social media, etc.). The sender may also respond to the staged transaction via a webpage or other interface on the send computer 16. In some embodiments, the sender may have the option to provide a partial approval with respect to an item indicating that the sender agrees to pay for a portion of the cost to fulfill the item. The sender may specify the portion to be fulfilled as a percentage of the total cost of the item or as a monetary amount. With respect to commodities, the sender may have the option to substitute commodities in the staged transaction with different commodities. For example, the seller may be provided with a link to a merchant's website to select substitute commodities. The substitute commodities may then be associated with the merchant's biller code for the staged transaction. The sender may alternatively be given access to a list of merchants affiliated with the system 10 to select substitute commodities.

In step 62, the server 20 receives the notification from the send computers 16 indicating whether the senders have approved or denied fulfillment of the items in the staged transaction. As noted above, and approval notification may comprise partial approval for the total cost of any the items. The server 20 may then process the senders' decisions, for example by storing the senders' decisions in association with the stored transaction request, and/or confirming that the senders' entered form of payment is legitimate and sufficient. The server 20 may also deduct any commissions or fees associated with the staged transaction from the funds provided by the senders.

In step 64, the receiver may review the fulfillment status of the requested items in the staged transaction. For example, the receiver may access account information via the receive computer 12 to review status information about the staged transaction. The status information may be provided on a webpage associated with the financial services organization that operates the system 10. For example, the status information may be provided after the receiver supplies login information to the webpage. In some embodiments, the server 20 provides the receiver with access to status information about the staged transaction after processing of the staged transaction to the central server 20. This embodiment is illustrated by the dashed line extending between steps 52 and 64. In some embodiments, the receiver is provided with substantially real-time status information with respect to the staged transaction. That is, the server 20 may update the status information provided to the receiver as responses are received from the senders.

In step 66, the receiver may request release of items that have been fulfilled by senders. For example, in the case of cash requests in the staged transaction that have been fulfilled, the receiver may send a request to server 20 via receive computer 12 to release the funds to the receiver. The funds may be deposited in an financial account associated with the receiver, or the receiver may retrieve the funds from a location approved by the financial services organization that operates the system 10. Then, upon approval, the requested fulfilled items are released to the receiver in step 68. Alternatively, the system 10 may automatically release some or all of the items from the staged transaction when the items are fulfilled by the senders.

In other embodiments, items in the staged transaction are automatically sent to the receiver upon fulfillment by the senders. For example, in the case of bill or expense payments, the fulfilled payments may be automatically forwarded to the identified billers when the server 20 confirms sufficiency and legitimacy of payment from the sender(s) after step 62. As another example, in the case of commodities, the merchant may receive notification (e.g., from the server 20) indicating that the fulfilled items may be shipped after the server 20 confirms payment from the senders in step 62.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A method for operating a computer system for a receiver-staged money transfer transaction, the method comprising:
receiving a staged transaction from a receiver, the staged transaction including one or more items requested by the receiver;
receiving information about one or more senders identified to receive the staged transaction;
sending the staged transaction to the one or more senders;
receiving approval notifications from the one or more senders indicating the one or more items in the staged transaction that the one or more senders agree to fulfill; and
releasing payment for the requested items fulfilled by the one or more senders.

2. The method of claim 1, wherein receiving information about the one or more senders comprises:
receiving category data for at least one of the one or more senders, the category data setting one or more categories of items in the staged transaction that are sent to the at least one of the one or more senders.

3. The method of claim 2, wherein sending the staged transaction to the one or more senders comprises:
sending items in the staged transaction associated with the one or more categories of items to the at least one of the one or more senders.

4. The method of claim 3, wherein the items in the staged transaction associated with the one or more categories of items are sent simultaneously to the at least one of the one or more senders.

5. The method of claim 3, wherein the items in the staged transaction associated with the one or more categories of items are sent sequentially to the at least one of the one or more senders until the one or more categories of items are fulfilled.

6. The method of claim 1, wherein the one or more senders comprises a plurality of senders, and wherein the step of receiving approval notifications comprises:
receiving approval notifications from more than one of the plurality of senders for a same item in the staged transaction request, wherein the more than one of the plurality of senders share a cost associated with the same item.

7. The method of claim 1, wherein receiving approval notifications from the one or more senders comprises:
receiving a partial approval notification from a sender indicating that the sender agrees to pay for a portion of a cost to fulfill one of the one or more items.

8. A system for facilitating staging of money transfer transactions by a receiver, the system comprising:
a server that communicates with a plurality of computers, the server configured to:
receive a staged transaction from a receiver, the staged transaction including one or more items requested by the receiver;
receive information about one or more senders identified to receive the staged transaction request;
send the staged transaction to the one or more senders;
receive approval notifications from the one or more senders indicating the one or more items in the staged transaction that the one or more senders agree to fulfill; and
release funds associated with the requested items fulfilled by the one or more senders.

9. The system of claim 8, wherein the server is further configured to receive category data for at least one of the one or more senders, the category data setting one or more categories of items in the staged transaction that are sent to the at least one of the one or more senders.

10. The system of claim 9, wherein the server is further configured to send the one or more categories of items in the staged transaction to the at least one of the one or more senders.

11. The system of claim 10, wherein the server sends the one or more categories of items simultaneously to the at least one of the one or more senders.

12. The system of claim 10, wherein the server sends the one or more categories of items sequentially to the at least one of the one or more senders until the one or more categories of items are fulfilled.

13. The system of claim 8, wherein the one or more senders comprises a plurality of senders, and wherein the server is configured to receive approval notifications from more than one of the plurality of senders for a same item in the staged transaction request, wherein the more than one of the plurality of senders share a cost associated with the same item.

14. The system of claim 8, wherein the server is configured to receive a partial approval notification from a sender indicating that the sender agrees to pay for a portion of a cost to fulfill one of the one or more items.

15. A method for operating a computer system to facilitate a receiver staged money transfer transaction, the method comprising:
providing a receiver interface on a receive computer that allows the receiver to generate a staged transaction request, the staged transaction including one or more items requested by the receiver;
prompting the receiver on the receiver interface to identify and select one or more senders to receive the staged transaction request;
providing a sender interface on one or more send computers that allows the one or more senders to review the one or more items requested in the staged transaction request;
prompting the one or more senders to approve or deny fulfillment of the one or more items; and
providing status information on the receiver interface as to whether each of the one or more items in the staged transaction has been fulfilled.

16. The method of claim 15, and further comprising:
providing an option on the receiver interface for the receiver to request release of the fulfilled one or more items.

17. The method of claim 15, wherein prompting the receiver to identify and select one or more senders comprises:
prompting the receiver for category data for the one or more senders, the category data setting one or more categories of items in the staged transaction that are sent to the one or more senders associated with the category data.

18. The method of claim 15, wherein the one or more senders are prompted to approve or deny fulfillment of the one or more items in parallel.

19. The method of claim 15, wherein the one or more senders are prompted to approve or deny fulfillment of the one or more items sequentially until the one or more categories of items are fulfilled.

20. The method of claim 15, wherein multiple senders approve fulfillment of a same item in the staged transaction request, and wherein the multiple senders share a cost associated with the same item.

21. The method of claim 15, wherein prompting the one or more senders to approve or deny fulfillment of the one or more items further comprises:
prompting the one or more senders to fully or partially approve fulfillment of the one or more items, wherein partial approval from a sender indicates that the sender agrees to pay for a portion of a cost to fulfill the one or more items.
